(19) United States
(12) Patent Application Publication
(10) Pub. No.: US 2009/0260766 A1
(43) Pub. Date: Oct. 22, 2009

(54) METHOD OF SECURELY OPERATING A HOME AUTOMATION SYSTEM

(76) Inventor: Stephane Lapierre, Sallanches (FR)

Correspondence Address: FROMMER LAWRENCE & HAUG LLP, 745 FIFTH AVENUE, NEW YORK, NY, 10151, US

(21) Appl. No.: 12/423,331

(22) Filed: Apr. 14, 2009

(30) Foreign Application Priority Data
Apr. 22, 2008 (FR) 08 02246

(51) Int. Cl. E05F 15/20

(52) U.S. Cl. 160/7

(57) ABSTRACT

A method of operating a home automation system comprising a closing screen, blackout or solar protection screen driven by an actuator and intended to block off an opening of a building, the screen comprising an end that moves between an open position corresponding to an open configuration of the screen and a closed position corresponding to a closed configuration of the screen, the actuator being controlled by at least one first command transmitter, wherein, when, in a preliminary step, the first command transmitter is designated as a blocked transmitter, the home automation system switches over to a first operating mode, in which displacements of the moving end controlled from the blocked transmitter are only prohibited when the moving end is in a security zone.

### BACKGROUND OF THE INVENTION

The invention relates to a method of operating a home automation system comprising a screen intended to block off an opening.

### DESCRIPTION OF THE PRIOR ART

Locking certain functions of a command transmitter following the execution of specific key press sequences is known. Thus, in patent FR 2 852 135, the performance of the sequence switches over the command transmitter controlling a screen to locked mode. In this mode, at least one key remains active while certain other keys are deactivated, the associated control commands being disabled. This solution makes it possible to block the use of the command transmitter for certain functions while maintaining security functions such as the stopping of the screen.

In certain applications, notably applications involving screens fitted in openings of rooms frequented by children, it is necessary to provide, to overcome safety problems, particular functionalities on the systems. The system described does not provide a way of resolving these security problems.

Another known security function consists in stopping the screen and/or raising it again if an obstacle positioned in the path of the screen is detected. This function is performed only if an obstacle is present and generally requires additional sensors to handle the detection (feeler bar, photoelectric cell, etc). This makes such systems complex and costly. These systems are also more difficult to install.

### SUMMARY OF THE INVENTION

The aim of the invention is to provide a method of operating a home automation system that overcomes these drawbacks and improves the operating methods known from the prior art. In particular, the invention proposes a method of operating a home automation screen system making the latter safe. Such an operating method can advantageously be implemented by an inexpensive and simply-structured home automation system. The operating method makes it possible notably to prevent limbs from being caught and defenestration.

The method according to the invention governs the operation of a home automation system comprising a closing screen, blackout or solar protection screen driven by an actuator and intended to block off an opening of a building. The screen comprises an end that moves between an open position corresponding to an open configuration of the screen and a closed position corresponding to a closed configuration of the screen. The actuator is controlled by at least one first command transmitter. In said method, when, in a preliminary step, the first command transmitter is designated as a blocked transmitter, the home automation system switches over to a first operating mode, in which displacements of the moving end controlled from the blocked transmitter are only prohibited when the moving end is in a security zone.

The prohibited displacements can be displacements of the moving end to the closed position.

The prohibited displacements can be displacements of the moving end outside the security zone, when the moving end is initially in the security zone.

The prohibited displacements can be any displacement of the moving end.

The entry of the system into the first operating mode and/or the exiting of the system from the first operating mode can be controlled by one or more actions on the first command transmitter.

The entry of the system into the first operating mode and/or the exiting of the system from the first operating mode can be controlled by one or more actions on a second command transmitter.

The system can comprise a screen with stackable slats and, in the first operating mode, the actions of the actuator controlled by the first command transmitter and designed to stack or unstack the slats without displacement of the moving end can be authorized.

The system can comprise a screen with directable slats and, in the first operating mode, the actions of the actuator controlled by the first command transmitter and designed to direct the slats without displacement of the moving end to the closed position can be authorized.

The system can comprise a screen with directable slats and, in the first operating mode, the actions of the actuator controlled by the first command transmitter and designed to direct the slats without displacement of the moving end can be authorized.

According to the invention, the home automation system comprises a closing screen, blackout or solar protection screen driven by an actuator and intended to block off an opening of a building. The screen comprises an end that moves between an open position corresponding to an open configuration of the screen and a closed position corresponding to a closed configuration of the screen. The actuator is controlled by at least one first command transmitter. The system further comprises hardware and/or software means for implementing the operating method defined previously.

### DESCRIPTION OF THE DRAWINGS

The invention will be better understood from reading the following description, given purely by way of example and with reference to the appended drawings in which:

FIGS. 1 and 4 are diagrams of a roller shutter making it possible to implement the operating method according to the invention;

FIGS. 5 and 6 are diagrams of a screen with directable slats making it possible to implement the operating method according to the invention;

FIG. 7 is a diagram of a mode of execution of the operating method according to the invention.

### DESCRIPTION OF THE PREFERRED EMBODIMENTS

The invention proposes a method of operating a home automation system comprising a screen intended to block off an opening and making it possible to provide a security function. A preliminary step for this method consists is designating a command transmitter as a blocked transmitter. This designation can be made on the command transmitter or on the command receiver. Once the transmitter has been designated, the method makes it possible to lock or disable, subject to certain conditions, the control commands sent by the blocked command transmitter so as to prevent a displacement of the screen that might create a hazard for a person, or more particularly a child, situated in the vicinity of the screen. In this case, the system is in a so-called locked operating mode. In this mode, only the blocked command transmitters are affected by the restrictions described hereinbelow. The solution consists, subject to certain conditions, in not authorizing any closure displacement or in authorizing no displacement of a moving end of the screen in a security zone. The moving end corresponds to the end of the screen that moves along the travel of the screen, between an open position of the screen and a closed position of the screen. The other end of the screen is generally fixed to a wind-on tube. The screen is, for example, of the type with stackable and/or directable slats. This can also be a garage door or a sliding door. The expression “open configuration” of the screen should be understood to mean a position of the moving end such that the screen at least partially clears the opening. Similarly, the expression “closed configuration” of the screen should be understood to mean a position of the moving end such that the screen at least partially blocks off the opening. Generally, these positions will have been defined in a configuration phase, so that an actuator operating the screen is automatically deactivated when the screen reaches one or other of these positions.

In the case of a screen with stackable slats, two closure configurations of the screen must be distinguished. The first corresponds to a closed configuration for which the moving end abuts against an edge or a threshold of the opening equipped with the screen. The opening is blocked off when the screen has reached this configuration. The screen may, however, not be completely deployed inasmuch as its slats can still be displaced. Such is notably the case for a roller shutter with stackable slats having openings between them. The screen can reach a configuration in which the last slat rests on the threshold of the opening but in which the slats are not adjoining, leaving an interstice between them making it possible to provide light and/or ventilation inside the room. The second closure configuration corresponds to an end-of-travel configuration. The screen is completely deployed. In the preceding example, that corresponds to the configuration in which the slats are adjoining (if the end-of-travel adjustment is correct).

To provide the desired security function, the home automation system configured in locked mode must not allow, based on a command from the blocked transmitter, any lowering displacement or not allow displacement of the moving end of the screen in a security zone delimited by, on the one hand, the closed position defined previously and, on the other hand, a predetermined intermediate position. This predetermined intermediate position is, preferably, a position of the moving end for which the screen is sufficiently open not to crush a part of the body of a person situated on the threshold of the opening. For example, this limit could correspond to the position of the moving end of a roller shutter situated 30 cm above the threshold of the opening. The closed position is that in which the moving end has reached the threshold of the opening.

Thus, if the screen is open, the locked home automation system can allow, based on a command from the blocked transmitter, the closure of the screen to the top limit of the security zone, leaving sufficient space not to crush a person or at least for the person to be able to be freed. In the case where the moving end is in the security zone and in the case where the system is in locked mode, the screen can be used as a security barrier, in which case the method does not allow, based on a command from the blocked transmitter, the opening of the screen to be commanded or allows it to be opened only until the limit of the security zone. The movements with which to adjust the lighting of the room are, however, allowed. This may be, for example, the angular orientation of slats or the stacking of slats from an “openwork slats” position to an “adjoining slats” position (or vice versa). It should be noted that the method can allow a slight displacement of the moving end if the latter is inherent to the angular orientation of the slats.

Consequently, according to the position of the moving end of the screen or according to the type of screen, the locking of the home automation system limits the authorized functions. For example, with a screen with directable slats for which the load bar is situated in the security zone, the blocked transmitter can control only the orientation of the slats. With a roller shutter whose final slat is not in the security zone, the blocked transmitter can control the closure of the shutter but the latter will be stopped automatically when the final slat reaches the top limit of the security zone. In this locked operating mode, the limiting of the functionalities can be done on the command transmitter by prohibiting the transmission of control commands (provided that the command transmitter knows the position of the bottom moving end of the screen) or on a command receiver, the latter disregarding the control commands sent by a command transmitter.

The entry into and/or the exiting from the locked operating mode of the home automation system can be obtained by a specific sequence of strokes on at least one key of a command transmitter. Because of this, security is enhanced in as much as the home automation system cannot easily be unlocked without knowing the appropriate combination. Similarly, this makes it possible not to accidentally switch over the system to a locked mode. The use of the keys of the command transmitter makes it possible to be independent of any other control element and to be sure of having locked/unlocked the system with respect to the right command transmitter. Indeed, locking may be effective only with respect to a single command transmitter or to a single group of command transmitters.

However, it may also be of interest to lock/unlock the system with respect to a command transmitter, remotely, in the case where it is not desired to act directly on the command transmitter concerned. For example, the command transmitter may be in a room where a child is sleeping and there is a desire, when he awakes, for the transmitter to be locked without risking waking up the child by entering the room to configure the transmitter. The remote configuration can be obtained through the intermediary of a second command transmitter. The home automation system can also be locked with respect to several command transmitters controlling one and the same screen. For example, in addition to locking the system with respect to the command transmitter situated in the vicinity of the screen whose operation could be hazardous for the person close to the screen, the system could also be locked with respect to a more remote command transmitter to avoid an accidental operation leading to a hazardous maneuver. A hazardous maneuver corresponds to the preceding conditions, namely, a closure displacement of the moving end of the screen in the security zone or a displacement of the moving end of the screen in the security zone.

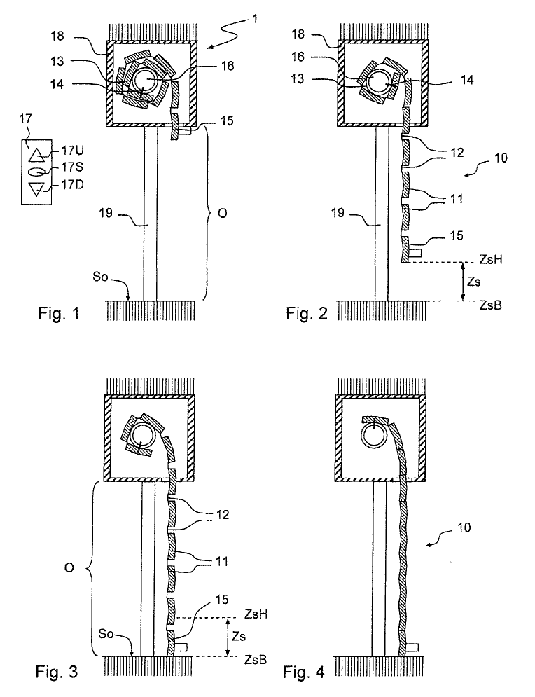

The operating method according to the invention is particularly suited to the two screen home automation systems illustrated in FIGS. 1 to 6.

The first type of home automation system 1, represented in FIGS. 1 to 4, comprises roller shutters provided with a shutter 10 consisting of articulated slats 11. The shutter is fixed on one side to a wind-on tube 13 by a fixing means 14 and on the other side to a final slat 15, hereinafter called “moving end” of the screen, so as to allow it to be wound onto the wind-on tube 13 or for it to be unwound from the tube 13 by an actuator, such as, for example, a motor 16 whose power supply is controlled by an electronic control unit (not represented). The actuator is controlled by at least one command transmitter 17 which can be of wired or wireless type or use another means of communication. Such a command transmitter can be part of the home automation system. The actuator 16 preferably has counting means making it possible to identify the state of deployment of the screen and notably the position of the moving end of the screen. The position of the moving end can also be obtained by other means such as external sensors positioned along the travel of the screen. The wind-on tube 13 is housed in a box frame 18 situated above an opening O embodied in glazing 19 in the figures mentioned.

The home automation system comprises a security zone Zs delimited by a top limit ZsH and a bottom limit ZsB. This zone must be defined in a system configuration step preliminary to the operating method according to the invention. The top limit corresponds to an arbitrary position of the final slat 15. The bottom limit corresponds to a position of the final slat 15 level with or close to the threshold So of the opening O.

FIG. 1 represents the roller shutter completely wound into the box frame.

FIG. 2 illustrates a configuration of the roller shutter for which the moving end has reached a position ZsH corresponding to the arbitrary top limit of a security zone Zs relating to the operating method according to the invention. This top limit can be defined by default or following a preliminary configuration operation. For example, the configuration can consist in switching over to learning mode, followed by the displacement of the moving end to the desired position and finally the recording of this position as the top limit.

FIG. 3 shows the shutter in “closed” configuration, that is, when the final slat has reached a threshold So of the opening O. The position ZsB of the moving end corresponds to the bottom limit of the security zone Zs defined previously. It should be noted that, in this configuration, the slats are open. Two consecutive slats are linked by a coupling 12 provided with openings making it possible for light to pass through. When the slats are open, the two consecutive slats are spaced apart by a distance roughly corresponding to the height of the coupling. Thus, the light can penetrate into the room, through the openings of the couplings.

FIG. 4 represents the roller shutter in bottom end-of-travel configuration. The slats are adjoining and the couplings are concealed. It should be noted that, between the “closed” configuration and the end-of-travel configuration, the position of the moving end does not change: it remains in position ZsB. During this change, the other slats move. The motor continues to drive the wind-on tube in rotation.

According to the invention, once the home automation system is configured in locked mode, the moving end of the screen cannot be displaced in the security zone Zs. Alternatively, it can be displaced only in the orientation of opening (raising in this particular case). In this case, it may preferably not be displaced above the position ZsH. This prohibition may concern only one command transmitter or a group of command transmitters, all the functions (and notably all the displacements of the moving end) remaining possible if they are controlled by another command transmitter.

Thus, if the roller shutter is in the configuration of FIG. 1, a command to close (lower) the shutter sent by the blocked transmitter 17 when the system is in a locked operating mode leads to the deployment of the screen until it reaches a limit of the security zone Zs. The action of the actuator and therefore the displacement of the final slat will therefore be stopped immediately as soon as the final slat of the roller shutter reaches the position ZsH, the configuration corresponding to FIG. 2.

If the moving end of the roller shutter is in the security zone Zs, without having reached its bottom or top limit, deployment configuration between FIGS. 2 and 3, no displacement of the moving end can be commanded. All the actions of the actuator allowing a displacement of the moving end and controlled by the blocked command transmitter are prohibited.

Alternatively, the moving end may be displaced only in the orientation of opening (raising). In this case, it may preferably not be displaced beyond the position ZsH.

This prohibition may relate to only one command transmitter or to a group of command transmitters, all the functions (and notably all the actions of the actuator allowing displacements of the moving end) remaining possible if they are controlled by another command transmitter.

In a third case, the final slat is at the level of the bottom limit ZsB of the security zone Zs. In this case, the home automation system can be controlled, in such a way that the wind-on tube rotates in order to adjust the openings of the slats and therefore the brightness of the room. On the other hand, the displacement of the moving end of the screen cannot be controlled.

This prohibition may relate to only one command transmitter or to a group of command transmitters, all the functions (and notably all the actions of the actuator leading to displacements of the moving end) remaining possible if they are controlled by another command transmitter.

As a variant, the security zone Zs corresponds to a unique position of the moving end (Zs=ZsB=ZsH). This variant facilitates the configuration and the processing of the restrictions induced by this operating method.

The entry into and/or the exiting from the locked operating mode can be obtained by the execution of a specific sequence of presses on keys 17U and/or 17S and/or 17D on the command transmitter. This configuration can also be obtained by an operation on a second command transmitter. In the locked operating mode, the limitation of the functionalities, that is the limitation of the possibilities of controlling the actions of the actuator, can be done on the command transmitter by prohibiting the transmission of control commands (provided that the command transmitter knows the position of the bottom moving end of the screen) or on a command receiver, the latter disregarding the control commands sent by a command transmitter. Different possibilities are then obtained.

In a first case, the limitation takes place on the command transmitter. It can consist in disabling certain keys. If they are actuated, no command is sent. For example, in the case of a screen with directable slats, only the control unit linked to orientation, such as a knob, remains activated when the screen is in the security zone. In this case, to implement the control method according to the invention, it is necessary for the command transmitter to know the position of the moving end of the screen or at least for it to know whether said moving end is or is not in the security zone.

In a second case, the limitation is obtained with the command receiver. Generally, this receiver is incorporated in the controlled actuator. The execution of a specific operation on the command transmitter leads to the sending of a specific command to the receiver. Following the reception of this specific command, the receiver considers the command transmitter to be a blocked transmitter. Thus, when the receiver receives a command from this transmitter, it is handled in a specific way and will be interpreted to provide the desired limitation. The blocking of a command transmitter can therefore be obtained remotely, with the command receiver.

According to other variants, the locked operating mode of the home automation system with respect to a first command transmitter is obtained through the intermediary of a second command transmitter. The execution of a specific operation on the second command transmitter leads to the sending of a specific command either to the first command transmitter for it to limit itself automatically, or to the command receiver for it to deal in an appropriate manner with the commands sent by the first command transmitter. These cases are then similar to the cases cited previously.

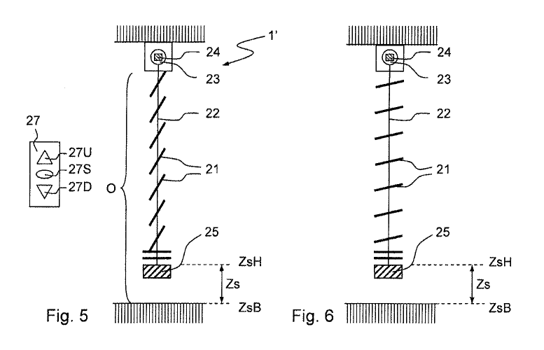

The second type of home automation system 1′, represented in FIGS. 5 and 6, comprises a blind provided with directable slats 21. The blind is provided with a bottom load bar 25, this load bar being fixed to the ends of ropes or strings 22 wound onto wind-on drums 23 driven in rotation by a spindle 24 linked to an actuator (not represented), the power supply of which is driven by an electronic control unit (not represented). The actuator is controlled by at least one command transmitter 27 which can be of wired or wireless type or use another means of communication. The actuator preferably has counting means making it possible to identify the state of deployment of the bind and notably the position of the moving end of the blind. The ropes pass through the slats 21. The blind is operated by the ropes. In practice, the winding of the latter onto the wind-on drums results in the load bar being lifted and, consequently, the slats being stacked one on top of the other. The blind also comprises means of orienting the slats (not represented) making it possible to adjust the angular position of the slats about their longitudinal axis, the latter being parallel to the axis of the load bar.

FIGS. 5 and 6 represent such a blind deployed in such a way that the moving end of the blind, namely the load bar, is situated in the security zone Zs defined in a manner similar to the previous embodiment. The moving end is therefore between the positions ZsH and ZsB. The difference between the two configurations represented is the orientation of the slats. These figures illustrate the application of the invention for this type of screen where only the orientation of the slats is possible, from the blocked transmitter, when the home automation system is locked and when the moving end is positioned in the security zone. It should be noted that the orientation of the slats can result in a slight displacement of the moving end of the blind. This movement is acceptable because it is minimal, the desired protection still being provided. When the screen is completely deployed, it serves as a security barrier to prevent anyone from passing through the opening O. The home automation system cannot then be controlled in such a way as to provoke the opening of the blind, namely the displacement of the moving end of the blind.

Similarly, the security zone Zs can correspond to a unique position of the moving end (Zs=ZsB=ZsH). For entry into and exiting from the locked operating mode, the configuration can be obtained by operations similar to those described in relation to the previous embodiment.

Another alternative is to prohibit any displacement of the screen. For the blinds, the orientation of the slats from the locked command transmitter can be authorized. This amounts to defining the security zone as corresponding to the entire travel of the shutter or blind. In this case, the operating method is simplified since there is no longer a need to know the position of the moving end of the screen, the displacement of the screen being systematically blocked except for that inherent in the orientation of the slats.

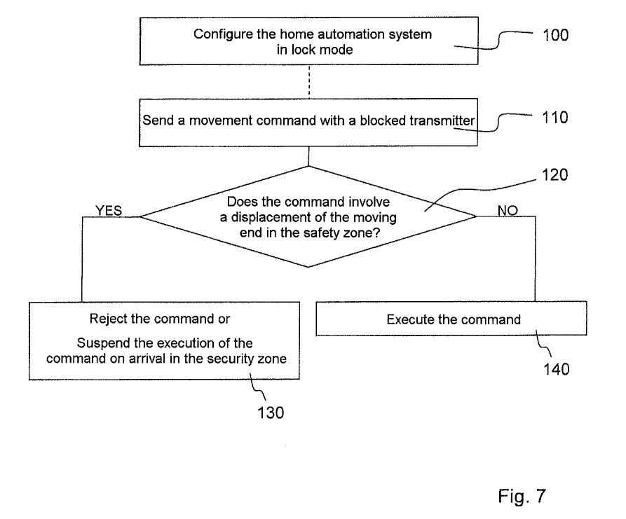

One mode of execution of the operating method according to the invention that can notably be applied to the above screens is described with reference to FIG. 7.

In a configuration step 100, the home automation system is configured in locked mode. The configuration operation can correspond, as stated previously, to the execution of a specific sequence of key presses on a command transmitter.

In a first step 110, a blocked command transmitter with respect to which the home automation system is locked, sends a screen movement command.

In a second step 120, if the movement command involves a displacement of the moving end in the security zone then the operation moves on to a third step 130. Otherwise, it moves on to a fourth step 140.

In the third step 130, the command sent by the blocked command transmitter is not executed if it is an actuator action command to displace the moving end when the latter is situated in the security zone. The step 130 includes an alternative in the case where the moving end is not situated in this zone. In this case, the actuator action command is executed and the moving end is displaced normally. However, immediately the moving end reaches a limit of the security zone, the action of the actuator is stopped automatically. The actions of the actuator displacing the moving end in the other direction can be authorized. Obviously, the screen can be stopped following a command to stop the action of the actuator before the moving end has reached one of the limits. As stated previously, in an execution variant, a displacement control command can be executed if it is an opening displacement of the screen. In this case, the displacement is preferably immediately stopped as soon as the position ZsH is reached.

In the fourth step 140, the command sent by the blocked command transmitter is executed. It should be noted that a very slight displacement of the moving end inherent in a slat orienting command does not constitute a command to displace the moving end within the meaning of the present invention. Such a command is therefore executed.

To facilitate the determination of the closed position of the screen, that is, the position for which the moving end abuts against an edge or a threshold of the opening, the latter can be estimated. It is possible, for example, to consider that this position corresponds to a percentage of the overall travel of the screen. For a roller shutter with openings, this percentage can be set at 85% of the overall travel to obtain the complete closure of the shutter, that is, slats adjoining. Determined in this way, the bottom limit ZsB of the security zone can correspond to a position of the screen for which the moving end is slightly above the threshold of the opening. The estimating of the closed position of the screen makes it possible to dispense with identifying this bottom limit of the security zone.

To make it possible to implement the operating method according to the invention, the home automation systems described previously comprise, among the hardware and/or software means for implementing the operating method according to the invention, a means of recording a first threshold ZsB, a means of recording a second threshold ZsH, a means of comparing the position of the moving end to the first and second thresholds, a means of controlling displacements of the screen and/or a means of controlling modifications of the orientation of the slats and a means of executing a predefined security scenario. The software means can comprise computer programs. The home automation system also comprises a hardware and/or software means governing the operation of the home automation system in a locked mode and a hardware and/or software means governing the operation of the home automation system in another operating mode.

Although not specifically described hereinabove, the home automation system can also operate in another so-called standard operating mode, in which all the functionalities, notably all the displacement functionalities, are active, regardless of the position of the moving end.

According to the invention, the locked operating mode of the home automation system can be defined as a particular so-called locked operating mode of one or more command transmitters intended to control the movements of the screen. Alternatively, the locked operating mode of the home automation system can be defined as a particular so-called locked operating mode of a command receiver receiving the control commands sent by one or more command transmitters intended to control the movements of the screen.

1. A method of operating a home automation system comprising a closing screen, blackout or solar protection screen driven by an actuator and intended to block off an opening of a building, the screen comprising an end that moves between an open position corresponding to an open configuration of the screen and a closed position corresponding to a closed configuration of the screen, the actuator being controlled by at least one first command transmitter, wherein, when, in a preliminary step, the first command transmitter is designated as a blocked transmitter, the home automation system switches over to a first operating mode, in which displacements of the moving end controlled from the blocked transmitter are only prohibited when the moving end is in a security zone.

2. The operating method as claimed in claim 1, wherein the prohibited displacements are displacements of the moving end to the closed position.

3. The operating method as claimed in claim 1, wherein the prohibited displacements are displacements of the moving end outside the security zone, when the moving end is initially in the security zone.

4. The operating method as claimed in claim 1, wherein the prohibited displacements are any displacement of the moving end.

5. The operating method as claimed in claim 1, wherein the entry of the system into the first operating mode and/or the exiting of the system from the first operating mode can be controlled by one or more actions on the first command transmitter.

6. The operating method as claimed in claim 1, wherein the entry of the system into the first operating mode and/or the exiting of the system from the first operating mode can be controlled by one or more actions on a second command transmitter.

7. The operating method as claimed in claim 1, wherein the system comprises a screen with stackable slats and wherein, in the first operating mode, the actions of the actuator controlled by the first command transmitter and designed to stack or unstack the slats without displacement of the moving end are authorized.

8. The operating method as claimed in claim 1, wherein the system comprises a screen with directable slats and wherein, in the first operating mode, the actions of the actuator controlled by the first command transmitter and designed to orient the slats without displacement of the moving end to the closed position are authorized.

9. The operating method as claimed in claim 1, wherein the system comprises a screen with directable slats and wherein, in the first operating mode, the actions of the actuator controlled by the first command transmitter and designed to direct the slats without displacement of the moving end are authorized.

10. A home automation system comprising a closing screen, blackout or solar protection screen driven by an actuator and intended to block off an opening of a building, the screen comprising an end that moves between an open position corresponding to an open configuration of the screen and a closed position corresponding to a closed configuration of the screen, the actuator being controlled by at least one first command transmitter, which system comprises hardware and/or software means for implementing the operating method as claimed in claim 1.

11. The operating method as claimed in claim 2, wherein the prohibited displacements are displacements of the moving end outside the security zone, when the moving end is initially in the security zone.
